(19) United States
(12) Patent Application Publication
(10) Pub. No.: US 2010/0096446 A1
(43) Pub. Date: Apr. 22, 2010

(54) ELECTRONIC STORAGE CARD READER AND CONTROL CHIP THEREOF

(75) Inventors: CHI-TUNG CHANG, Taipei (TW); Shih-Min Lan, Taipei (TW); I-Chieh Lin, Taipei (TW)

Correspondence Address: KILE GOEKJIAN REED & MCMANUS, 1200 NEW HAMPSHIRE AVE, NW, SUITE 570, WASHINGTON, DC, 20036, US

(73) Assignee: ALCOR MRCOR, CORP.

(21) Appl. No.: 12/486,857

(22) Filed: Jun. 18, 2009

(30) Foreign Application Priority Data
Oct. 20, 2008 (TW) 97218712

(51) Int. Cl. G06F 17/00

(52) U.S. Cl. 235/375

(57) ABSTRACT

An electronic storage card reader applied to a computer system includes a system port, a control chip, a first card insertion part, and a second card insertion part. The system port is connected to a computer system. The control chip is connected to the system port for converting and transmitting data with the computer system. Each of the first card insertion part and the second card insertion part includes a plurality of card insertion slots connected with the control chip and provided for inserting a memory card. The control chip independently accesses the memory cards inserted into the card insertion slots of the first card insertion part, integrates the memory cards inserted into the card insertion slots of the second card insertion part to form a merged storage space, and accesses the merged storage space. The invention allows the electronic storage card reader to have a single larger storage capacity.

### CROSS-REFERENCE TO RELATED APPLICATION

This application claims priority under 35 U.S.C. §119 to Taiwan Patent Application No. 097218712, filed on Oct. 20, 2008, in the Taiwan Intellectual Property Office, the entire contents of which are hereby incorporated by reference.

### BACKGROUND OF THE INVENTION

1. Field of the Invention

The present invention relates to an electronic storage card reader, and more particularly to an improved electronic storage card reader and its control chip with a function of integrating the capacity of several memory cards.

2. Description of Related Art

As storage media advance, flash memory related devices have been used extensively by the general public. Since various types of memory cards and their applications have become increasingly popular, card readers become one of the necessary peripherals of computers to access data of a memory card through a computer. Electronic storage card readers usually support several different types of memory cards and provide convenient application, and thus electronic storage card reader has become the most convenient medium for transmitting data between memory cards and computers. In the meantime, the memory card and the card reader feature the data portability of a computer.

Present computers, regardless of desktop or notebook computers, tend to be light, thin, short and compact to avoid occupying too much space. Although such design can overcome the issue of occupying much space, it also makes the upgrade or expansion of a computer difficult and even requires external connections to achieve the upgrade or expansion function.

For instance, if a user finds out the available store capacity of a computer hard disk insufficient, he/she may want to add a hard disk for expansion. If the space in the interior of the desktop computer is limited or a notebook computer can install only one hard disk then the user has to replace the installed hard disk with another one of a larger store capacity. Alternately, an external hard disk is connected to the computer to achieve the expansion effect. Obviously, such replacement incurs high costs and inconvenience of usage.

If the user wants to increase the store capacity of the aforementioned computer by means of an electronic storage card reader, the user may need several memory cards for duplicating or pasting files for saving data in different memory cards, since the present design of the electronic storage card reader emphasizes the portability of accessing data of a computer through the memory cards. Therefore, the present electronic storage card readers may not be able to satisfy the user requirements for using the memory card as a fixed disk for storing data.

Therefore, finding a way of improving the electronic storage card reader to meet the user requirement for expanding the store capacity of a computer demands immediate attentions and feasible solutions.

### SUMMARY OF THE INVENTION

In view of the shortcomings of the prior art, the inventor of the present invention overcomes the shortcomings of the prior art by using the original feature of an electronic storage card reader that accesses a memory card, and integrates a plurality of memory cards inserted into the plurality of memory card insertion slots by a firmware program to form a merged storage space, so as to provide a single storage capacity to satisfy the requirement of expanding the store capacity of a computer system.

To achieve the foregoing objective, the present invention provides an improved electronic storage card reader, applied to a computer system, and comprising: a system port, a plurality of card insertion slots and a control chip. The system port is connected to the computer system, and each of the card insertion slots is provided for inserting a memory card, and the control chip is connected to the system port and the card insertion slots, and the control chip integrates the memory cards inserted into the card insertion slots to form a merged storage space, accesses the merged storage space and performs data conversion and transmission with the computer system.

To achieve the foregoing objective, the present invention provides an electronic storage card reader and its control chip, and the electronic storage card reader is applied to a computer system, and the control chip comprises a signal transmission module, a card interface engine and a kernel unit. The signal transmission module is connected to a system port of the electronic storage card reader, and performs serial data conversion and data transmission to and from the computer system, and the card interface engine is connected to a plurality of card insertion slots of the electronic storage card reader for driving and controlling the memory cards inserted into the card insertion slots. The kernel unit is connected to the signal transmission module and the card interface engine for controlling the operation of transmitting data between the computer system and the memory cards. The kernel unit is designed for integrating and controlling the memory cards inserted into the card insertion slots to form a merged storage space.

To achieve the foregoing objective, the present invention further provides an improved electronic storage card reader applied to a computer system, and the electronic storage card reader comprises: a system port, a control chip, a first card insertion part and a second card insertion part. The system port is connected to the computer system, and the control chip is connected to the system port, for performing data conversion and transmission with the computer system. In addition, the first card insertion part and the second card insertion part comprise a plurality of card insertion slots connected to the control chip and inserted separately with a memory card. The control chip can be designed for accessing the memory card inserted into the card insertion slot of the first card insertion part independently and integrating the memory cards inserted into the card insertion slots of the second card insertion part to form a merged storage space, and accessing the merged storage space.

To achieve the foregoing objective, the present invention provides an electronic storage card reader and its control chip, and the electronic storage card reader is applied to a computer system, and the control chip comprises: a signal transmission module, a card interface engine and a kernel unit. The signal transmission module is connected to a system port of the electronic storage card reader, for performing serial data conversion and data transmission to and from the computer system, and the card interface engine corresponding to a first card insertion part and a second card insertion part is connected to a plurality of card insertion slots of the electronic storage card reader for driving and controlling the memory cards inserted into the card insertion slots. The kernel unit is connected to a signal transmission module and a card interface engine for controlling the operation of accessing data between the computer system and the memory cards. The kernel unit is designed for independently controlling the memory cards inserted into the card insertion slots of the first card insertion part to form separate independent storage spaces, and integrating and controlling the memory cards inserted into the card insertion slots of the second card insertion part to form a merged storage space.

To achieve the effects of the present invention, users can insert several memory cards into the multi-slot electronic storage card reader to integrate the memory cards into a single store space with a large storage capacity without requiring additional costs and facilitate users to use the memory cards as a fixed storage space to achieve the effect of expanding the store capacity of the computer system.

The above and other objects, features and advantages of the present invention will become apparent from the following detailed description of preferred embodiments taken with the accompanying drawings, but the preferred present invention, but not intended for limiting the scope of the invention.

### BRIEF DESCRIPTION OF THE DRAWINGS

FIG. 1 is a system block diagram of an electronic storage card reader in accordance with the present invention;

FIG. 2 is a schematic view of an application of an electronic storage card reader in accordance with the present invention; and

FIG. 3 is a block diagram of an electronic storage card reader and a control chip in accordance with the present invention,

### DETAILED DESCRIPTION OF THE PREFERRED EMBODIMENTS

The present invention uses the original feature of an electronic storage card reader that accesses a memory card, and integrates a plurality of memory cards inserted into the plurality of memory card insertion slots by a firmware program to form a merged storage space, so as to provide a single larger storage capacity to satisfy the requirement of expanding the store capacity of the computer system.

In practical applications, a preferred embodiment of the electronic storage card reader in accordance with the present invention integrates the memory cards inserted into all card insertion slots of the electronic storage card reader into a merged storage space, or integrates the memory cards inserted into some of the card insertion slots into a merged storage space, and the memory cards inserted into the rest of the card insertion slots are individually provided for the access by users. To give a detailed description of the electronic storage card reader of the present invention, the following preferred embodiment adopts the aforementioned second mode as described below.

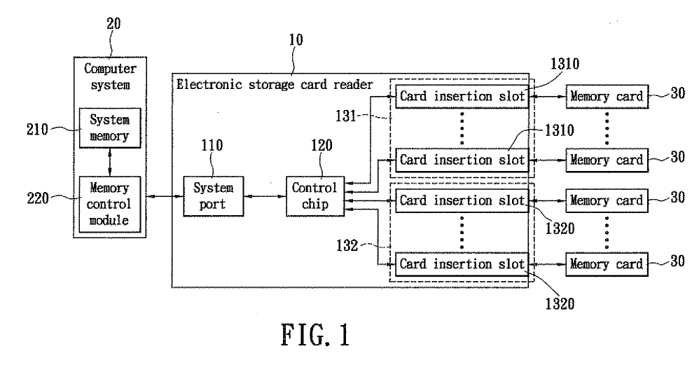

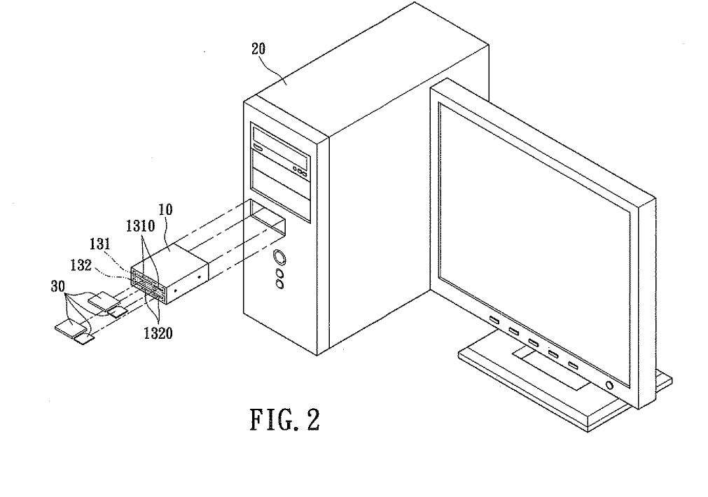

With reference to FIGS. 1 and 2 for a block diagram and a schematic view of an application of an improved electronic storage card reader in accordance with a preferred embodiment of the present invention, the electronic storage card reader 10 is applied to a computer system 20, and the electronic storage card reader 10 is embedded into the computer system 20. In FIG. 2, the computer system 20 is a desktop computer. Of course, other computers such as a notebook computer can be used for the practical applications.

In this embodiment, the electronic storage card reader 10 comprises: a system port 110, a control chip 120, a first card insertion part 131 and a second card insertion part 132. The first card insertion part 131 and the second card insertion part 132 have a plurality of card insertion slots 1310 and 1320 provided for users to insert a memory card 30 respectively.

The system port 110 can be a universal serial bus (USB) or a serial advanced technology attachment (SATA) interface port provided for connecting the computer system 20. The control chip 120 is connected between the system port 110 and the card insertion slots 1310, 1320 for converting and transmitting data between the computer system 20 and the memory cards 30, and the control chip 120 is designed for independently accessing the memory cards 30 inserted into the card insertion slots 1310 of the first card insertion part 131, integrating the memory cards 30 inserted into the card insertion slots 1320 of the second card insertion part 132 into a merged storage space, and accessing the merged storage space.

The control chip 120 further comprises a plurality of sets of control/data pins (not shown in the figure), and each set of control/data pins is provided for connecting a card insertion slot 1310, 1320 to control a single memory card 30. Therefore, the control chip 120 can be connected to the card insertion slots 1310 of the first card insertion part 131 and the card insertion slots 1320 of the second card insertion part 132 through the sets of control/data pins. For example, if the control chip 120 has four sets of control/data pins (bus 0˜3), and the control chip 120 is designed for independently controlling first and second sets of control/data pins, and integrating and controlling the third and fourth sets of control/data pins, and thus the first and second sets of control/data pins are connected to the card insertion slots 1310 of the first card insertion part 131, and the third and fourth sets of control/data pins are connected to the card insertion slots 1320 of the second card insertion part 132.

It is noteworthy to point out that the control chip 120 is designed for independently controlling the card insertion slots 1310 of the first card insertion part 131, and thus the control chip 120 responds a logical unit number (LUN) to the computer system 20 according to the number of sets of control/data pins connected to the card insertion slots 1310 of the first card insertion part 131. In other words, the computer system 20 can display a number of disk slots provided for users to operate and use according to the same number of the card insertion slots 1310 in the first card insertion part 131. Since the control chip 120 integrates and controls the card insertion slots 1320 of the second card insertion part 132, therefore the control chip 120 only responds one logical unit number to the computer system 20 according to all card insertion slots 1320 of the second card insertion part 132, and the computer system 20 only display one disk slot provided for the operation and use by users.

The aforementioned card insertion slots 1310, 1320 can be designed as a combination of insertion slots with one or more memory card specifications. In other words, the card insertion slots 1310 of the first card insertion part 131 and the card insertion slots 1320 of the second card insertion part 132 can be insertion slots with different specifications or the same specification, depending on the specification and type of the memory card supported by the control chip 120, and having no particular limitation. In FIG. 2, the first card insertion part 131 and the second card insertion part 132 are insertion slots with different memory card specifications.

With the operation of the electronic storage card reader 10 in accordance with this embodiment, users can use the first card insertion part 131 for the original feature of the electronic storage card reader 10 to achieve the data portability of the memory card 30, and use the memory card 30 inserted into the second card insertion part 132 as a fixed disk to expand the storage space of the computer system 20. Users can use several memory cards 30 for storing a large quantity of data. In addition, the storage medium of the flash memory is used to substitute a general external hard disk, so as to enhance the access performance.

On the other hand, the computer system 20 comprises at least one system memory 210, which is generally a dynamic random access memory (DRAM) provided for the CPU (not shown in the figure) to compute and transmit data. If the computer system 20 further comprises a memory control module 220, users can integrate any external flash memory device connected to the computer system 20 into an extended memory of the system through the setup of the memory control module 220 to expand the system memory 210, so as to enhance the processing performance of the computer system 20. In a practical design, the memory control module 220 can be built in an operating system (such as the Ready Boost and Ready-Drive functions of the Microsoft Vista® operating system) of the computer system 20 or externally installed to the software program of the operating system.

If the computer system 20 works together with the electronic storage card reader 10 of the present invention, users can set the memory control module 220 to control and drive a merged storage space formed by the memory card 30 inserted into the second card insertion part 132 of the electronic storage card reader 10 to become an extended memory to expand the system memory 210. Of course, the aforementioned controlled and driven merged storage space can be expanded to a larger extended memory, but not limited to such arrangement only, and users can set the memory control module 220 to control and drive any memory card 30 inserted into the first card insertion part 131 of the electronic storage card reader 10 to become an extended memory.

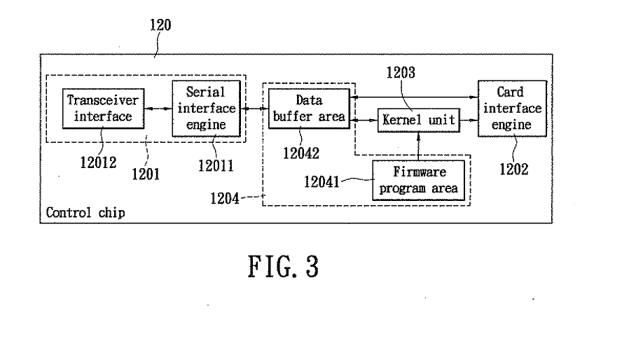

With reference to FIG. 3 for the aforementioned electronic storage card reader 10 and control chip 120 in accordance with a preferred embodiment of the present invention, the electronic storage card reader 10 and the control chip 120 comprise: a signal transmission module 1201, a card interface engine 1202, a kernel unit 1203 and a memory module 1204. The signal transmission module 1201 is connected to the system port 110, for conducting serial data conversion and data transmission to and from the computer system 20 through the system port 110. The signal transmission module 1201 comprises: a serial interface engine 12011 and a transceiver interface 12012. The serial engine interface 12011 is used for performing serial data conversion, and the transceiver interface 12012 is connected to the serial engine interface 12011 and the system port 110 for transmitting and receiving data. The signal transmission module 1201 is provided for the encoding, encoding, error correction, bit stuffing, conversion, transmitting and receiving processes for the serial signals.

The card interface engine 1202 is coupled to the card insertion slot 1310, 1320 corresponding to the first card insertion part 131 and the second card insertion part 132 respectively for controlling and driving the memory cards 30 connected to the card insertion slots 1310, 1320. The card interface engine 1202 has the plurality of sets of control/data pins provided for connecting the card insertion slot 1310 of the first card insertion part 131 and the card insertion slot 1320 of the second card insertion part 132 respectively.

The kernel unit 1203 is connected to the signal transmission module 1201 and the card interface engine 1202 for controlling the operation of accessing data between the computer system 20 and the memory cards 30. The kernel unit 1203 is designed for independently controlling the memory card 30 inserted into the card insertion slot 1310 of the first card insertion part 131 to form an independent storage space, and integrating the memory card 30 inserted into the card insertion slot 1320 of the second card insertion part 132 to form a merged storage space.

The memory module 1204 further comprises: a firmware program area 12041 and a data buffer area 12042. The firmware program area 12041 is connected to the kernel unit 1203, for storing a parallel program (not shown in the figure), and the data buffer area 12042 is connected to the serial interface engine 12011 of the signal transmission module 1201 and the card interface engine 1202, and receiving a control of the kernel unit 1203 to buffer the data transmitted between the computer system 20 and the memory card 30. In a practical design, the firmware program area 12041 is a read only memory (ROM), and the data buffer area 12042 is a random access memory (RAM).

In summation of the description, the present invention integrates and controls a plurality of memory cards inserted into the card insertion slots of the electronic storage card reader to define a single merged storage space and provide single larger storage capacity, so that users can use the merged storage space as a fixed disk for storing a large quantity of data or as a larger extended memory to expand the system memory, so as to achieve the purpose of fully expanding the store capacity of the computer system.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electronic storage card reader, applied to a computer system, and comprising:
a system port, coupled to the computer system;
a plurality of card insertion slots, each provided for inserting a memory card; and
a control chip, coupled to the system port and the card insertion slots, for integrating the memory cards inserted in the card insertion slots in order to form a merged storage space, for accessing the merged storage space, and for performing data conversion and transmission with the computer system.

2. The electronic storage card reader of claim 1, wherein the card insertion slots are a combination of insertion slots with one or more memory card specifications.

3. The electronic storage card reader of claim 2, wherein the electronic storage card reader is embedded into the computer system.

4. The electronic storage card reader of claim 2, wherein the computer system further comprises:
at least one system memory; and
a memory control module, for controlling and driving the merged storage space to become an extended memory to expand the system memory.

5. The electronic storage card reader of claim 1, wherein the control chip further comprises:
a signal transmission module, coupled to the system port, for performing serial data conversion and data transmission to and from the computer system;
a card interface engine, coupled to the card insertion slots, for driving and controlling the memory cards; and
a kernel unit, coupled to the signal transmission module and the card interface engine, for controlling a data access operation between the computer system and the memory cards;
wherein the kernel unit integrates and controls the memory cards inserted into the card insertion slots to become the merged storage space.

6. The electronic storage card reader of claim 5, wherein the control chip further comprises a memory module, and the memory module comprises:
a firmware program area, coupled to the kernel unit, for storing a parallel program; and
a data buffer area, coupled to the signal transmission module and the card interface engine, for buffering data transmitted between the computer system and the memory cards.

7. The electronic storage card reader of claim 6, wherein the firmware program area is a read only memory (ROM) and the data buffer area is a random access memory (RAM).

8. The electronic storage card reader of claim 6, wherein the signal transmission module comprises:
a serial interface engine, coupled to the data buffer area, for performing serial data conversion; and
a transceiver interface, coupled to the serial interface engine and the system port for receiving and transmitting data.

9. An electronic storage card reader, applied to a computer system, and comprising:
a system port, coupled to the computer system;
a control chip, coupled to the system port, for performing data conversion and transmission with the computer system;
a first card insertion part; and
a second card insertion part;
wherein the first card insertion part and the second card insertion part include a plurality of card insertion slots respectively, and the card insertion slots are coupled to the control chip for inserting a memory card into each of them;
and the control chip independently accesses the memory cards inserted into the card insertion slots of the first card insertion part, and integrates the memory cards inserted into the card insertion slots of the second card insertion part to form a merged storage space, and accesses the merged storage space.

10. The electronic storage card reader of claim 9, wherein the card insertion slots are a combination of insertion slots with one or more memory card specifications.

11. The electronic storage card reader of claim 10, wherein the electronic storage card reader is embedded into the computer system.

12. The electronic storage card reader of claim 10, wherein the control chip includes a plurality of sets of control/data pins, and the control chip is coupled to the card insertion slots of the first card insertion part and the card insertion slots of the second card insertion part by a design of dividing the sets of control/data pins.

13. The electronic storage card reader of claim 10, wherein the computer system further comprises:
at least one system memory; and
a memory control module, for controlling and driving the merged storage space to become an extended memory for expanding the system memory.

14. The electronic storage card reader of claim 13, wherein the memory control module further controls and drives a memory card inserted into any card insertion slot of the first card insertion part to form the extended memory.

15. A control chip applied to an electronic storage card reader as recited in claim 9, comprising:
a signal transmission module, coupled to the system port, for performing a serial data conversion and data transmission with the computer system;
a card interface engine, corresponding to the first card insertion part and the second card insertion part and coupled to the card insertion slots, for driving and controlling the memory cards; and
a kernel unit, coupled to the signal transmission module and the card interface engine, for controlling the operation of accessing data between the computer system and the memory cards;
wherein, the kernel unit independently controls the memory cards inserted into the card insertion slots of the first card insertion part to form an independent storage space, and integrates and controls the memory cards inserted into the card insertion slots of the second card insertion part to form the merged storage space.

16. The control chip of claim 15, wherein the card interface engine includes a plurality of sets of control/data pins, and the card interface engine is coupled to the card insertion slots of the first card insertion part and the card insertion slots of the second card insertion part through the sets of control/data pins respectively.

17. The control chip of claim 16, further comprising a memory module, and the memory module comprising:
a firmware program area, coupled to the kernel unit, for storing a parallel program; and
a data buffer area, coupled to the signal transmission module and the card interface engine, for buffering data transmitted between the computer system and the memory cards.

18. The control chip of claim 17, wherein the firmware program area is a read only memory (ROM) and the data buffer area is a random access memory (RAM).

19. The control chip of claim 17, wherein the signal transmission module comprises:
a serial interface engine, coupled to the data buffer area, for performing serial data conversion; and
a transceiver interface, coupled to the serial interface engine and the system port, for receiving and transmitting data.
